(19) United States
(12) Patent Application Publication
(10) Pub. No.: US 2006/0146008 A1
(43) Pub. Date: Jul. 6, 2006

(54) Method for calibrating an electrophoretic dispaly panel

(76) Inventors: Mark Thomas Johnson, Eindhoven (NL); Peter Eddy Wierenga, Eindhoven (NL); Guofu Zhou, Eindhoven (NL); Neculai Ailenei, Heerlen (NL)

Correspondence Address: PHILIPS INTELLECTUAL PROPERTY & STANDARDS, P.O. BOX 3001, BRIARCLIFF MANOR, NY, 10510, US

(21) Appl. No.: 10/562,169

(22) PCT Filed: Jun. 23, 2004
(86) PCT No.: PCT/IB04/50971

§ 371 Date: Dec. 22, 2005

(30) Foreign Application Priority Data
Jun. 26, 2003 (EP) 03101907.8

(51) Int. Cl. G09G 3/34

(52) U.S. Cl. 345/107

(57) ABSTRACT

The invention relates to a method for calibrating an electrophoretic display panel (1) comprising a plurality of pixels (2) capable of representing at least two optical states by receiving driving signals (30), comprising the steps of displaying a first calibration image (22) containing said optical states in a first arrangement on said electrophoretic display panel and providing driving signals (30) to said pixels (2) corresponding to a required image (23) resulting in a second calibration image (24) containing said optical states in a second arrangement on said electrophoretic display panel (1). The second calibration image (24) is compared with said required image (23) to determine differences (26) between said second calibration image (24) and said required image (23) and said driving signals (30) are adjusted in accordance with said differences such that said second calibration image (23) and said required image (24) match. By this method the uniformity of the electrophoretic display (1) is improved.

The invention relates to a method for calibrating an electrophoretic display panel comprising a plurality of pixels capable of representing at least two optical states by receiving driving signals.

U.S. Pat. No. 2002/0,196,526 discloses an electrophoretic device, wherein a driving voltage is applied over a first and a second electrode to allow electrophoretic particles to localize at either the first or the second electrode by electrophoresis.

In more recent electrophoretic displays multiple optical states are obtained via e.g. time-weighted drive periods or division of the pixels into surfaces with different areas.

A problem associated with the known electrophoretic display panels is non-uniformity, which is especially observed when changing from one optical state to another. In particular, the display panels have been observed to suffer from a form of image retention, whereby the actual grey level of a pixel in a new image may depend upon the grey level of that pixel in a previous image. In such cases, a previous image may be partially visible in a new image. These problems are believed to be caused by strong memory effects (bi-stability) and dwell time effects. The dwell time of a particular display pixels is generally defined as the period in which no voltage was applied to that pixel.

It is an object of the invention to provide a method for calibrating an electrophoretic display panel and in particular to reduce the form of image retention described above.

This object is achieved by the method comprising the steps of:
displaying a first calibration image containing said optical states in a first arrangement on said electrophoretic display panel;
providing driving signals to said pixels corresponding to a required image resulting in a second calibration image containing said optical states in a second arrangement on said electrophoretic display panel;
comparing said second calibration image with said required image to determine differences between said second calibration image and said required image;
adjusting said driving signals in accordance with said differences such that said second calibration image and said required image match.

By providing driving signals corresponding to a required image but resulting in a second calibration image and comparing the second calibration image with the required image, pixels or groups of pixels can be determined on the electrophoretic display for which the transition of the optical states do not result in the required optical state of the required image. After having determined the differences, also referred to as artefacts, these artefacts are repaired by adjusting the driving signals for the pixels in accordance with the differences observed, such that the required image is obtained. As a result the display panel uniformity is improved and, more specifically, the effects of image retention are reduced. This calibration method preferably constitutes a step in the manufacturing of an electrophoretic display. Preferably, the optical states are grey levels.

In a preferred embodiment of the invention the driving signals corresponding to said required image are provided such that all possible optical state transitions are involved in comparison with said first calibration image. In this situation it is possible to determine all artefacts at once.

In a preferred embodiment of the invention said first arrangement and said second arrangement comprise one or more blocks of individual pixels or groups of pixels of said display panel. The blocks may substantially entirely cover said electrophoretic display panel. By having several repeats of the calibration patterns of blocks distributed over the electrophoretic display panel, lateral, i.e. variations across the display panel, artefacts can be determined. As a result, the display panel uniformity is also improved. It may occur that the driving signals need to be adjusted differently for different locations on the display panel.

In a preferred embodiment the second calibration image is recorded by a CCD-camera to determine said differences between said second calibration image and said required image. The CCD-camera may record the second calibration image and therefore determine the deviations from the required image for the entire display panel at once.

In a preferred embodiment of the invention the electrophoretic display panel comprises a look-up table with driving signals corresponding to transitions between said optical states for said pixels and said method further comprises the step of modifying said look-up table in accordance with said adjusted driving signals. Before calibration a default look-up table may be present used in driving the pixels. It may appear that this default look-up table needs to be modified after the determination of the artefacts for adjusting the driving signals. Preferably these driving signals relate to driving voltages, reset voltages and/or pre-pulse voltages and said adjustment involves modifying the magnitude and/or duration of said voltages and/or changing or introducing periods between the driving voltages and/or adding additional voltage pulses. This modification allows restoration of the optical states or grey levels in accordance with the required image.

In an embodiment of the invention the step of displaying said first calibration image comprises the steps of:
recording said first calibration image and comparing said first calibration image with a further calibration image;
adjusting said driving signals such that said first calibration image and said further calibration image match.

By also recording the first calibration image, e.g. by the CCD-camera, information on the initial or first arrangement can be obtained. This first arrangement of the first calibration image may need to be adjusted in order to arrive at a suitable block of grey scale levels to obtain a transition for all possible optical states or grey levels on providing the driving signals corresponding to the required image, as described above.

In an embodiment of the invention the method further comprises the step of providing further driving signals to said pixels corresponding to further required images and resulting in further calibration images and comparing at least one of said further calibration images with said further required images. This may prove to be advantageous in improving the uniformity across the electrophoretic display panel. Moreover such further calibration images may be used in situations wherein the previous history of the pixels is important, i.e. not the previous image, but two or more images ago. In this case a third calibration image may be used wherein each block is split into smaller blocks with different optical states or grey levels.

In an embodiment of the invention the above method is repeated one or more times after adjusting said driving signals. By such a repetition of the method it may be verified whether the adjusted driving signals actually improved the uniformity of the electrophoretic display panel.

The invention also relates to a display device having an electrophoretic display panel comprising a plurality of pixels capable of representing at least two optical states, said device comprising:
means for displaying a first calibration image containing said optical states in a first arrangement on said electrophoretic display panel;
means to provide driving signals to said pixels corresponding to a required image having as a result a second calibration image containing said optical states in a second arrangement, and
means for adjusting said driving signals to match said second calibration image and said required image.

It should be noted that, although the above method and display device according to the invention involve a plurality of pixels, the invention and aspects thereof as described above applies mutatis mutandis to a method and display device for a single pixel as well.

In particular, the invention also relates to a method for calibrating an electrophoretic display panel comprising a pixel capable of representing at least two optical states by receiving driving signals, comprising the steps of:
displaying a first optical state for said pixel on said electrophoretic display panel;
providing a driving signal to said pixel corresponding to a required optical state having as a result said first optical state or a second optical state for said pixel on said electrophoretic display panel
comparing said resulting first or second optical state with said required optical state for said pixel to determine a difference between said resulting first or second optical state and said required optical state;
adjusting said driving signal in accordance with said difference such that said resulting first or second optical state and said required optical state of said pixel match.

Moreover, the invention relates to a display device having an electrophoretic display panel comprising a pixel capable of representing at least two optical states by receiving driving signals, said device comprising:
means for displaying a first optical state for said pixel on said electrophoretic display panel;
means to provide a driving signal to said pixel corresponding to a required optical state having as a result said first optical state or a second optical state for said pixel on said electrophoretic display panel, and
means for adjusting said driving signal to match said resulting first optical state or second optical state and said required optical state.

Accordingly, a single pixel display device can be calibrated. Of course, the driving signal may have as a result that the second optical state already matches the required optical state, in which case the second optical state is the required optical state. Further, preferably the optical states are grey levels.

U.S. Pat. No. 6,473,065 discloses methods for improving display uniformity of organic light emitting displays by calibrating individual pixels. In this publication only lateral non-uniformity variations are adjusted for, whereas according to the invention primarily optical state transitions are adjusted. Moreover, as the prior art methods are aimed at organic displays instead of electrophoretic displays, a single measurement is sufficient for improving the uniformity, since no substantial memory effects for uniformity occur for organic pixels.

In contrast, for electrophoretic displays strong memory effects arise resulting in the need for generating at least two calibration images.

The invention will be further illustrated with reference to the attached drawings, which show preferred embodiments of the invention. It will be understood that the device and method according to the invention are not in any way restricted to this specific and preferred embodiment.

In the drawings:

FIG. 1 shows a schematic illustration of an electrophoretic display panel;

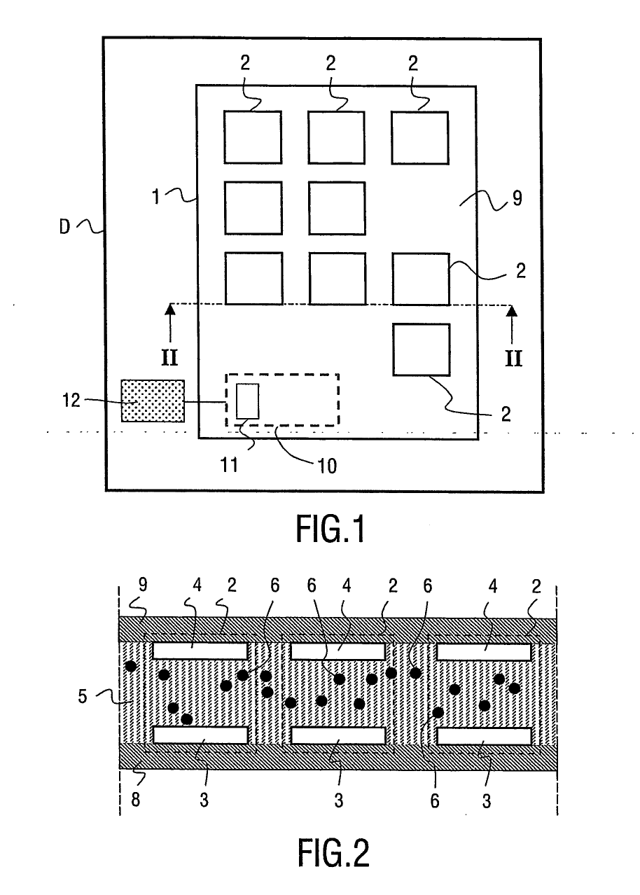

FIG. 2 shows a cross-section view along II-II in FIG. 1;

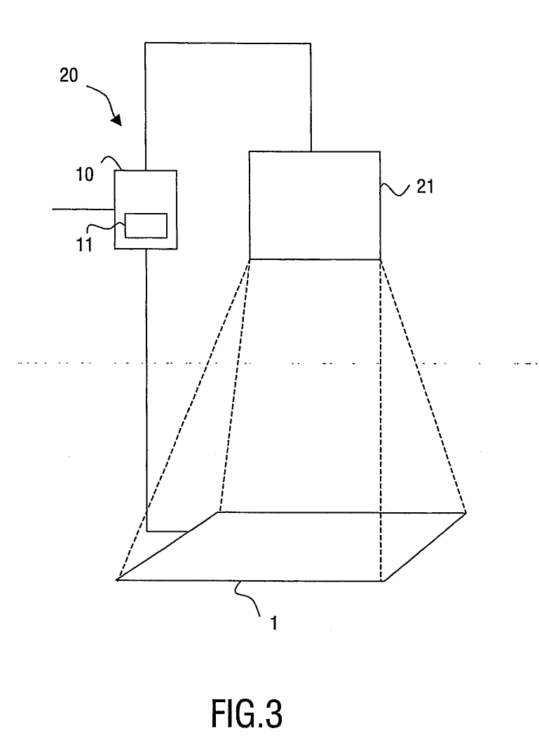

FIG. 3 shows a schematic illustration of a set-up for performing the method according to an embodiment of the invention;

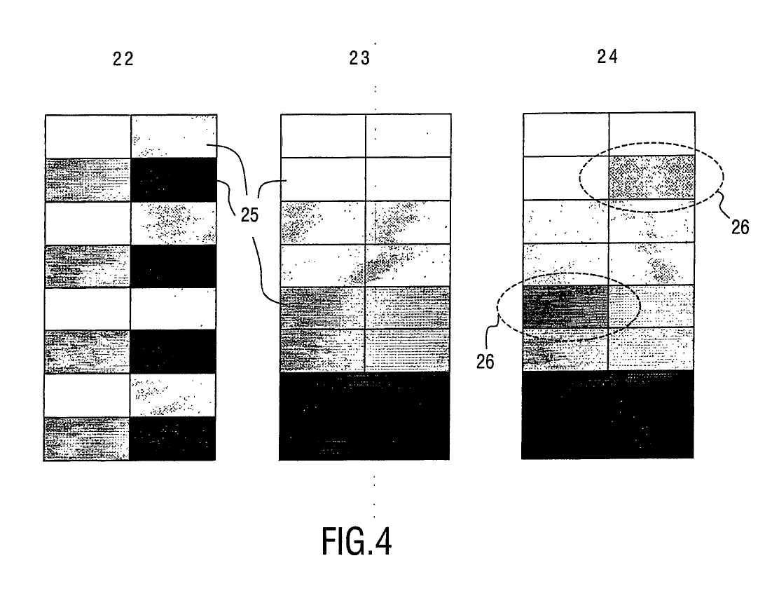

FIG. 4 shows examples of calibration images and a required image according to an embodiment of the invention;

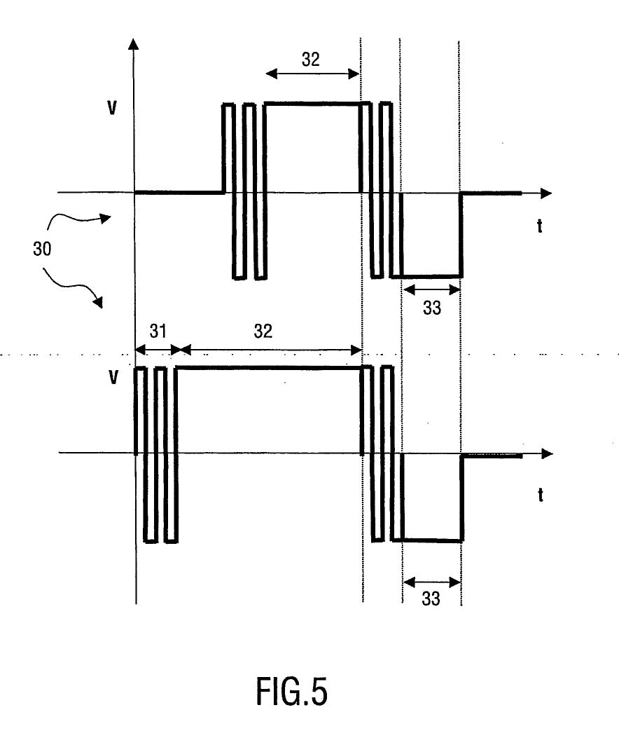

FIG. 5 shows examples of adjusted driving signals as a result of the method according to an embodiment of the invention, and

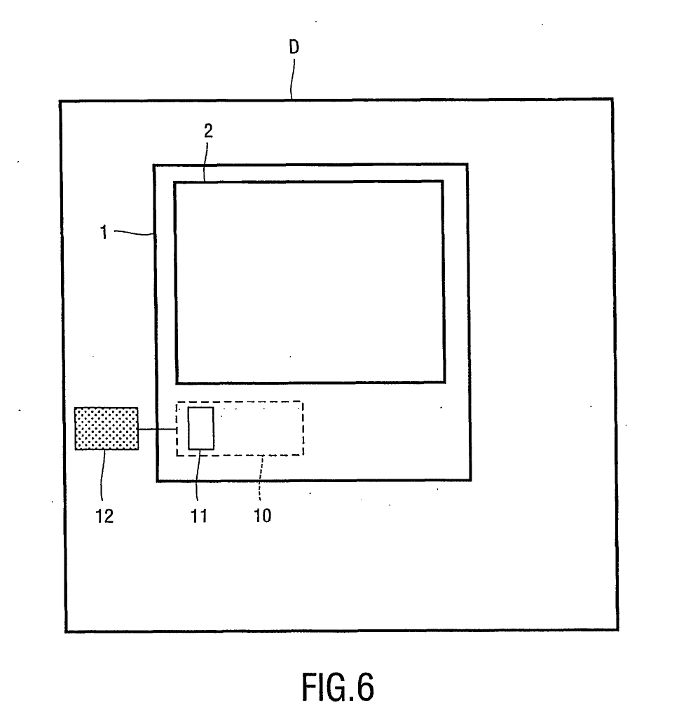

FIG. 6 shows a schematic illustration of a display device with an electrophoretic display panel comprising a single pixel.

FIGS. 1 and 2 show an embodiment of an electrophoretic display panel 1 of a device D having a first substrate 8, a second opposed substrate 9 and a plurality of pixels 2.

Preferably, the pixels 2 are arranged along substantially straight lines in a two-dimensional structure. Other alternatives include e.g. a honeycomb structure. An electrophoretic medium 5, having charged particles 6, is present between the substrates 8 and 9. In FIG. 2 the first substrate 8 has for each pixel 2 a first electrode 3, and the second substrate 9 has for each pixel 2 a second electrode 4. The electrodes 3, 4 are adapted to receive a driving signal from drive means 10. The charged particles 6 are able to occupy extreme positions near the electrodes 3,4 and intermediate positions in between the electrodes 3,4. In this way different optical states can be obtained. Hereinafter, these optical states are assumed to be grey levels. Each pixel 2 has an appearance determined by the position of the charged particles 6 between the electrodes 3,4 for displaying the picture or image. Electrophoretic media 5 are known per se from e.g. U.S. Pat. No. 5,961,804, U.S. Pat. No. 6,120,839 and U.S. Pat. No. 6,130,774 and can e.g. be obtained from E Ink Corporation. As an example, the electrophoretic medium 5 comprises negatively charged black particles 6 in a white fluid. When the charged particles 6 are in a first extreme position, i.e. near the first electrode 3, as a result of the potential difference being e.g. 15 Volts, the appearance of the pixel 2 is e.g. white. Here it is considered that the picture element 2 is observed from the side of the second substrate 9. When the charged particles 6 are in a second extreme position, i.e. near the second electrode 4, as a result of the potential difference being of opposite polarity, i.e. −15 Volts, the appearance of the pixel 2 is black. When the charged particles 6 are in one of the intermediate positions, i.e. in between the electrodes 3,4, the pixel 2 has one of the intermediate appearances, e.g. light grey and dark grey, which are grey levels between white and black. The drive means 10 is arranged for driving each pixel 2 by supplying appropriate voltages to the electrodes 3, 4 using a look-up table (LUT) 11. Appropriate driving signals are e.g. described in the non-prepublished patent application EP 03100133 of the applicant. In an active matrix embodiment, the pixel may further comprise switching electronics comprising for example thin film transistors (TFTs), diodes or MIM devices.

Further the display device D comprises means 12 for calibrating the electrophoretic display panel I according to an embodiment of the invention. The means 12 are arranged to communicate with the drive means 12 to generate driving signals.

FIG. 3 shows a schematic illustration of a set-up 20 for performing the method according to an embodiment of the invention. The set-up 20 comprises the electrophoretic display panel 1 shown in FIGS. 1 and 2, drive means 10 and a CCD-camera 21.

The operation of the set-up 20 will be described with reference to FIG. 4, showing a first calibration image 22, a required image 23 and a second calibration image 24. The images 22, 23 and 24 are divided in arrangements of blocks 25 of pixels 2 covering the entire display panel 1. Alternatively a multiplicity of such arrangements may be distributed over the electrophoretic display panel 1 to visualize lateral non-uniformity effects.

The first arrangement for the first calibration image 22 is such that it comprises all possible, in this case four, grey levels, indicated by the white (W), light grey (LG), dark grey (DG) and black (B) blocks 25. The second arrangement of the second calibration image 24 is chosen such that in the transition from the first calibration image 22 to the second calibration image 24 all grey level transitions are involved. That is, for compliance to the required image 23, the upper four blocks 25 should all switch to W, the subsequent four blocks 25 to LG, the next four blocks 25 to DG and the bottom four blocks 25 to B. Further calibration images may be displayed if need be. In this manner, memory effects persisting over more than one image update may also be corrected for. It is further noted that different arrangements for the calibration images are possible, depending upon details of the display I and the resolution of the optical measurement system 21.

In operation the fabricated electrophoretic display is placed under an optical imaging system, such as the CCD-camera 21. Then the display 1 may be initialized to a well-defined state by providing particular driving signals from the drive means 10. Next the first calibration image 22 is generated on the display panel 1 and the brightness of the grey levels for the pixels 2 is recorded by the CCD-camera 21. If the brightness of the initial grey levels is not correct the driving signals are adjusted in accordance with the results of the measurements for the CCD-camera 21. The adjustments may be stored in the LUT 11. The display panel I may be initialized once more and the first calibration image 22 may be re-displayed until the correct brightness levels are obtained as shown in FIG. 4.

Subsequently driving signals are provided corresponding to a required image 23 resulting in the second calibration image 24. By comparing the second calibration image 24 with the required image 23, differences 26 arising from image retention and other effects can be determined between the second calibration image 24 and the required image 23. The required image 23 represents the ideal image when all grey level transitions were successfully obtained. Here the artefacts are twofold, the transition B to W yielded a not entirely white block 25, whereas the transition W to DG yielded a too dark block 25.

The driving signals are adjusted in accordance with the differences 26 for the pixels 2 of the blocks 25. This adjustment may be achieved by modifying the LUT 11 of the drive means 10.

If necessary the display 1 may be re-initialized and the method may be repeated with new driving signals.

The display device D may comprise means 12, such as a button, to display the first calibration image 22. Subsequently, e.g. by pushing or turning the button 12, driving signals are provided corresponding to the required image 23 having as a result the second calibration image 24. Finally the means 12 or other means can be used to adjust the driving signals as to match the second calibration image 24 and the required image 23. Accordingly, means are provided to enable consumers to calibrate the electrophoretic display panel 1. It should be appreciated that the means 12 may comprise a plurality of control means for performing the calibration steps described above.

FIG. 5 shows an example of suitable driving signals 30 for the pixels 2 of the electrophoretic display panel 1. These driving signal include pre-pulse voltages 31, driving voltages 33 and optionally reset voltages 32. The pre-pulse voltages 31 may release the particles 6 from their extreme positions near the electrodes 3, 4 without enabling the particles to substantially transfer to the other electrode 3, 4. The reset voltages 32 may reduce the dependence of a pixel 2 on the previous appearance or representation because the particles 6 substantially occupy an extreme position. It is noted that the time during which the reset voltage 32 is applied may be extended as described in the non-pre-published patent application EP 03100133 of the applicant. The driving voltage 33 transfers the particles 6 to the position corresponding to the image information for the pixel 2. Adjustment of the driving signals 30 to calibrate the display panel I may include adjusting the magnitude and duration of the pre-pulse voltages 31 and/or the reset voltages 32 and/or the driving voltages 33, but may also involve changing or introducing periods between the driving voltages 33 in the dwell time and/or introducing additional voltage pulses. This adjustment is preferably performed by modifying the LUT 11.

Finally, in FIG. 6 a display device D is shown comprising an electrophoretic display panel 1 having a single pixel 2 capable of representing at least two optical states. The display device D comprises means 12 to control the calibration of the display panel 1. Again, it should be appreciated that the means 12 may comprise a plurality of control means for performing the calibration steps.

First the means 12, such as a button, are employed to display a first optical state for the single pixel 2 on the electrophoretic display panel 1. Subsequently, the button 12 is manipulated to provide a driving signal to the pixel 2 corresponding to a required optical state. The driving signal results in either the first optical state or a second optical state, which result is compared with the required optical state. If the resulting first or second optical state differs from the required optical state, the button 12 may be employed to adjust the driving signal from the drive means 10 to match the second optical state and the required optical state. Of course, the set-up 20 displayed in FIG. 2 employing a CCD-camera 21 may be used as well.

1. A method for calibrating an electrophoretic display panel (1) comprising a plurality of pixels (2) capable of representing at least two optical states by receiving driving signals (30), comprising the steps of:
displaying a first calibration image (22) containing said optical states in a first arrangement on said electrophoretic display panel;
providing driving signals (30) to said pixels (2) corresponding to a required image (23) resulting in a second calibration image (24) containing said optical states in a second arrangement on said electrophoretic display panel (1);
comparing said second calibration image (24) with said required image (23) to determine differences (26) between said second calibration image (24) and said required image (23);
adjusting said driving signals (30) in accordance with said differences such that said second calibration image (23) and said required image (24) match.

2. The method according to claim 1, wherein said optical states are grey levels.

3. The method according to claim 1, wherein said driving signals corresponding to said required image are provided such that all possible optical state transitions are involved in comparison with said first calibration image.

4. The method according to claim 1, wherein said first arrangement and said second arrangement comprise one or more blocks (25) of individual pixels or groups of pixels of said display panel.

5. The method according to claim 4, wherein said blocks substantially entirely cover said electrophoretic display.

6. The method according to claim 1, further comprising the step of recording said second calibration image by a CCD-camera (21) to determine said differences between said second calibration image and said required image

7. The method according to claim 1, wherein said electrophoretic display panel comprises a look-up table (11) with driving signals corresponding to transitions between said optical states for said pixels and said method further comprises the step of modifying said look-up table in accordance with said adjusted driving signals.

8. The method according to claim 1, wherein said driving signals comprise driving voltages (33), and/or reset voltages (32) and/or pre-pulse voltages (31) and said adjustment involves modifying the magnitude and/or duration of said voltages and/or changing or introducing periods between the driving voltages and/or introducing additional voltage pulses.

9. The method according to claim 1, wherein said step of displaying said first calibration image (22) comprises the steps of:
recording said first calibration image and comparing said first calibration image with a further calibration image;
adjusting said driving signals such that said first calibration image and said further calibration image match.

10. The method according to claim 1, wherein said method further comprises the step of providing further driving signals to said pixels corresponding to further required images and resulting in further calibration images and comparing at least one of said further calibration images with said further required images.

11. The method according to claim 1, wherein said method is repeated one or more times after adjusting said driving signals.

12. A display device (D) having an electrophoretic display panel (1) comprising a plurality of pixels (2) capable of representing at least two optical states, said device comprising:
means (12) for displaying a first calibration image (22) containing said optical states in a first arrangement on said electrophoretic display panel (1);
means (12) to provide driving signals (30) to said pixels corresponding to a required image (23) having as a result a second calibration image (24) containing said optical states in a second arrangement, and
means (12) for adjusting said driving signals (30) to match said second calibration image (24) and said required image (23).

13. The display device (D) according to claim 12, wherein said optical states are grey levels.

14. The display device (D) according to claim 12, wherein said device further comprises a look-up table (11) with driving signals corresponding to transitions between said optical states for said pixels and said means for adjusting said driving signals are adapted to modify said look-up table in accordance with said adjusted driving signals.

15. A method for calibrating an electrophoretic display panel (1) comprising a pixel (2) capable of representing at least two optical states by receiving driving signals (30), comprising the steps of:
displaying a first optical state for said pixel on said electrophoretic display panel (1);
providing a driving signal (30) to said pixel corresponding to a required optical state having as a result said first optical state or a second optical state for said pixel on said electrophoretic display panel
comparing said resulting first or second optical state with said required optical state for said pixel to determine a difference between said resulting first or second optical state and said required optical state;
adjusting said driving signal in accordance with said difference such that said resulting first or second optical state and said required optical state of said pixel match.

16. A display device (D) having an electrophoretic display panel (1) comprising a pixel (2) capable of representing at least two optical states by receiving driving signals (30), said device comprising:
means (12) for displaying a first optical state for said pixel on said electrophoretic display panel (1);
means (12) to provide a driving signal (30) to said pixel corresponding to a required optical state having as a result said first optical state or a second optical state for said pixel on said electrophoretic display panel, and
means (12) for adjusting said driving signal (30) to match said resulting first optical state or second optical state and said required optical state.
